(19) United States
(12) Patent Application Publication
(10) Pub. No.: US 2005/0213207 A1
(43) Pub. Date: Sep. 29, 2005

(54) MICROSCOPE HAVING A DEVICE FOR CORRELATING THE DIAPHRAGM OF A CONDENSER WITH THE OBJECTIVE CURRENTLY IN USE

(75) Inventors: Jasna Roeth, Solms (DE); Manfred Gilbert, Schoeffengrund (DE)

Correspondence Address: SIMPSON & SIMPSON, PLLC, 5555 MAIN STREET, WILLIAMSVILLE, NY, 14221-5406, US

(73) Assignee: LEICA MICROSYSTEMS WETZLAR GMBH, Wetzlar (DE)

(21) Appl. No.: 10/906,422

(22) Filed: Feb. 18, 2005

(30) Foreign Application Priority Data
Mar. 26, 2004 (DE) 10 2004 015 482.1

(51) Int. Cl. G02B 21/06

(52) U.S. Cl. 359/388; 359/368

(57) ABSTRACT

A microscope having a device for correlating a diaphragm of a condenser with the objective currently in use is disclosed. The microscope possesses a nosepiece on which are mounted several objectives, of which one in each instance is in the working position. In addition, a condenser having at least one displaceable diaphragm setting ring is arranged opposite the objective. The diaphragm setting ring has associated with it at least one identifying component that encompasses several individual different elements. Each of the objectives carries an element that corresponds respectively to an element on the identifying component.

### CROSS REFERENCE TO RELATED APPLICATIONS

This application claims priority of the German patent application 10 2004 015 482.1, filed Mar. 26, 2004, which is incorporated by reference herein.

### FIELD OF THE INVENTION

The present invention concerns a microscope.

### BACKGROUND OF THE INVENTION

German Patent DE 40 36 065 discloses a condenser turret for a microscope. An indicating apparatus is provided that indicates which elements of the condenser have been introduced into the beam path of the microscope. No correlation exists between the objective present in the beam path and the condenser setting.

Leica brochure “Leica DM L” discloses a condenser having a diaphragm setting ring and an identifying component. Here as well, no disclosure is apparent that ensures a correlation of an objective present in the beam path with a suitable diaphragm setting of the condenser.

### SUMMARY OF THE INVENTION

The object on which the present invention is based is therefore to create a microscope having a device with which a user arrives at an unequivocal correlation between the objective present in the working position and the diaphragm of the condenser.

The aforesaid object is achieved by a microscope comprising: a condenser; a nosepiece which carries a plurality of objectives with an objective currently in a working position, wherein one objective in each instance is brought by the nosepiece in the working position, at least one displaceable diaphragm setting ring provided at the condenser to adjust a diaphragm of the condenser, wherein the at least one diaphragm setting ring has associated with it an identifying component that encompasses several individual different elements; and each of the objectives carries an element that corresponds respectively to an element on the identifying component.

What has been recognized according to the present invention is that at least one diaphragm setting ring has associated with it an identifying component that encompasses several individual different elements. Each of the objectives carries an element that corresponds respectively to an element on the identifying component. An index that indicates the position of the diaphragm setting ring is mounted on the diaphragm setting ring. The identifying component is provided above the diaphragm setting ring. The elements of the identifying component and the elements on the objectives are of the same type. The elements differ from one another in terms of color, among other factors.

The elements on the identifying component and on the objectives inserted in the nosepiece are implemented in raised fashion. In another embodiment, the elements on the identifying component and on the objectives inserted in the nosepiece are applied as engraving. The elements on the identifying component and on the objectives inserted in the nosepiece can likewise be applied as overprinting. The overprinting can be color overprinting.

The position of each element on the identifying component corresponds to an aperture size of the condenser diaphragm that is optimal for the objective that is in a working position and is equipped with the same element. Setting of the optimum aperture is accomplished by the fact that an index on the diaphragm setting ring points to the element that is applied on the objective that is in the working position.

### BRIEF DESCRIPTION OF THE DRAWINGS

There are various possibilities for advantageously implementing and developing the teaching of the present invention. The reader is referred for that purpose on the one hand to the claims subordinate to claim 1, and on the other hand to the explanation below of preferred exemplifying embodiments of the invention with reference to the drawings. Generally preferred implementations and developments of the teaching are also explained in conjunction with the explanation of the preferred exemplifying embodiments. In the drawings:

FIG. 1 is a frontal view of the microscope in which an exemplifying embodiment of the teaching according to the present invention is implemented;

FIG. 2 is an enlarged view of the region of the microscope that contains the invention;

FIG. 3 is an enlarged view of a further embodiment of the region of the microscope that contains the invention;

FIG. 4 shows an embodiment of the implementation of an element on the objective;

FIG. 5 shows a further embodiment of the implementation of the element on the objective; and

FIG. 6 shows an embodiment of the identifying component that is implemented as an adhesive label.

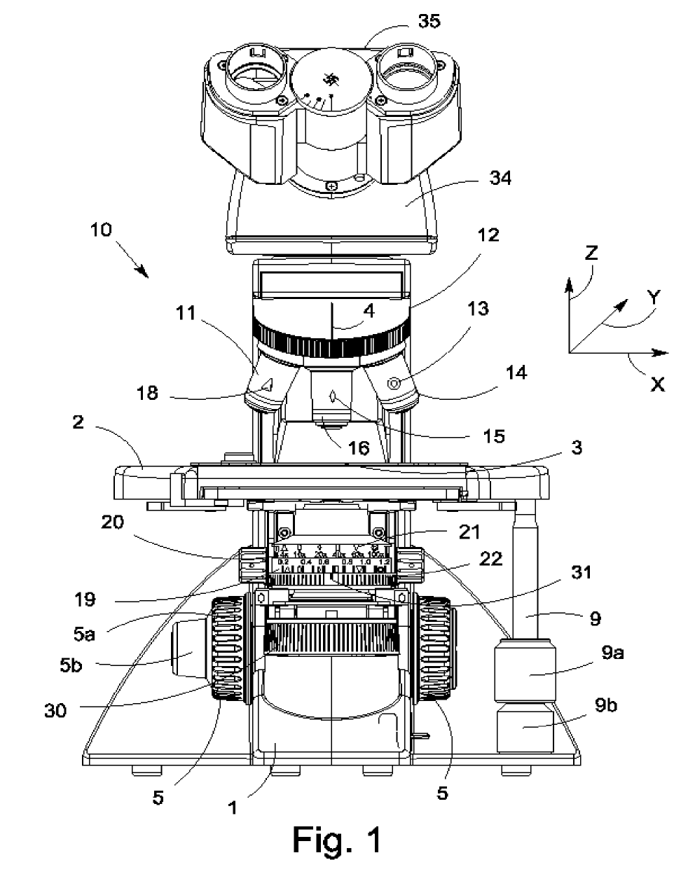

In FIGS. 1 through 6, identical or similar components are identified with the same reference characters.

### DETAILED DESCRIPTION OF THE INVENTION

FIG. 1 is a frontal view of microscope 10 in which an exemplifying embodiment of the teaching according to the present invention is implemented. Microscope 10 encompasses a stand 1 on which a microscope stage 2 is mounted. A condenser 30 is provided beneath microscope stage 2. A nosepiece 12 is mounted on stand 1 opposite condenser 30. Nosepiece 12 carries several objectives 11, 14, 16 that can be respectively introduced by a user into a working position 4. The working position is that position of an objective 11, 14, 16 with which a user performs a microscopic examination of a sample 3 present on microscope stage 2. In the setting shown in FIG. 1, objective 16 is in the working position.

Microscope stage 2 is equipped with a displacement element 9 with which microscope stage 2 can be shifted in an X direction and a Y direction. For this purpose, displacement element 9 possesses an X displacement element 9a and a Y displacement element 9b. Microscope 10 also encompasses a displacement device 5 for the Z direction, with which microscope stage 2 is moved in the Z direction. The displacement device encompasses at least one first and one second actuation element 5a and 5b, each of which encompasses a fine focus and a coarse focus.

Condenser 30 is equipped with at least one displaceable diaphragm setting ring 22. Correlated with diaphragm setting ring 22 is an identifying component 19 that encompasses several individual different elements 21. Each of the objectives 11, 14, 16 carries an element 13, 15, 18 that respectively corresponds to an element on identifying component 19. An index 31 that indicates the position of diaphragm setting ring 22 is provided on diaphragm setting ring 22. The setting that matches the respective objective 11, 14, 16 exists when index 31 points toward the element of identifying component 19 which corresponds to the element with which objective 16 that is currently in working position 4 is equipped. In addition to identifying component 19 of condenser 30, an information element 20 that displays to the user the correlation of the individual elements with the individual magnifications of the objectives can also be provided on the condenser. Microscope 10 furthermore carries a tube 34 that is equipped with a binocular eyepiece 35.

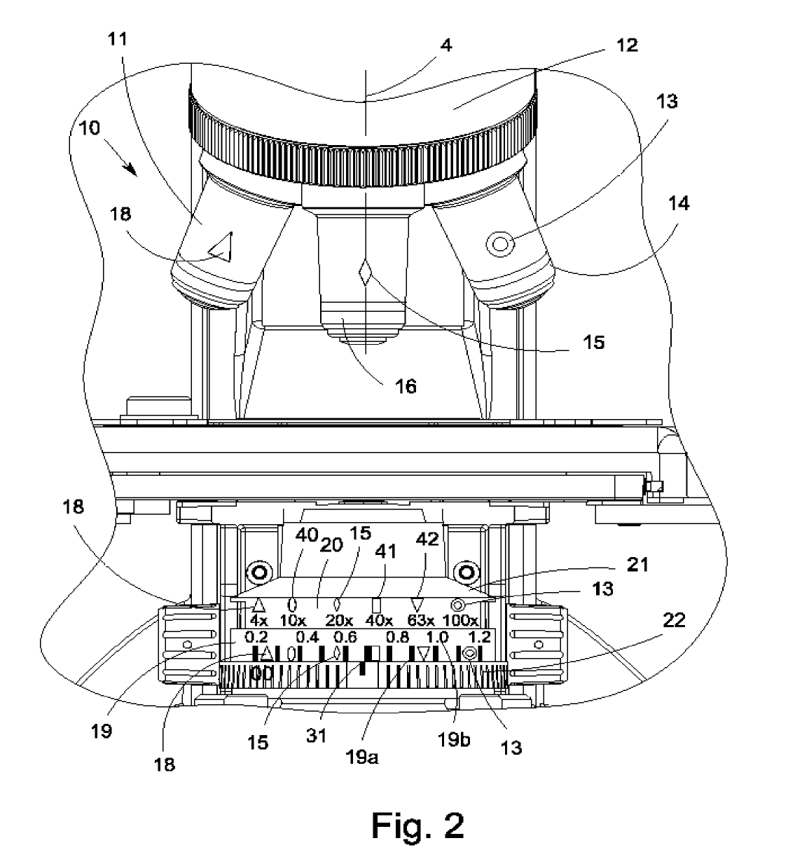

FIG. 2 is an enlarged view of the region of microscope 10 of FIG. 1 that contains the invention. In this embodiment, elements 13, 15, 18 on objectives 11, 14, 16 and on identifying component 19 are embodied as graphical shapes. As depicted in FIG. 2, an objective 11 is provided with a triangle 18, an objective 16 with a rhombus 15, and a further objective 14 with a ring 13. The fact that only three objectives are shown in the depiction of FIG. 2 is by absolutely no means to be construed as a limitation. Provided above diaphragm setting ring 22 is identifying component 19, on which is mounted a graduated scale 19a that is additionally provided with numerical values 19b. Numerical values 19b indicate a relative value of the diaphragm opening. In addition, the elements for correlating the diaphragm opening of condenser 30 with objective 16 that is in the working position are reproduced between the graduations. Diaphragm setting ring 22 is equipped with an index 31 which is set to the element applied on objective 11, 14, 16 that is currently in the working position. In addition to identifying component 22 of condenser 30, an information element 20 is provided that displays to the user the correlation of the individual elements with the individual magnifications of objectives 11, 14, 16. In the exemplifying embodiment depicted here, the magnifications of the individual objectives, for example 4×, 10×, 20×, 40×, 63×, 100×, are present on information element 20. Correlated with each of the magnifications of the individual objectives is an element that, in this embodiment, is a respective graphical shape. The four-times magnification 4× has an upright triangle 18 associated with it, the ten-times magnification 10× an ellipse 40, the twenty-times magnification 20× a rhombus 15, the forty-times magnification 40× a rectangle 41, the sixty-three-times magnification 63× an inverted triangle 42, and the hundred-times magnification 100× a ring 13. The setting of the diaphragm of condenser 30 which matches objective 16 that is in working position 4 is achieved when index 31 on diaphragm setting ring 22 is in line with element (in this case, the rhombus).

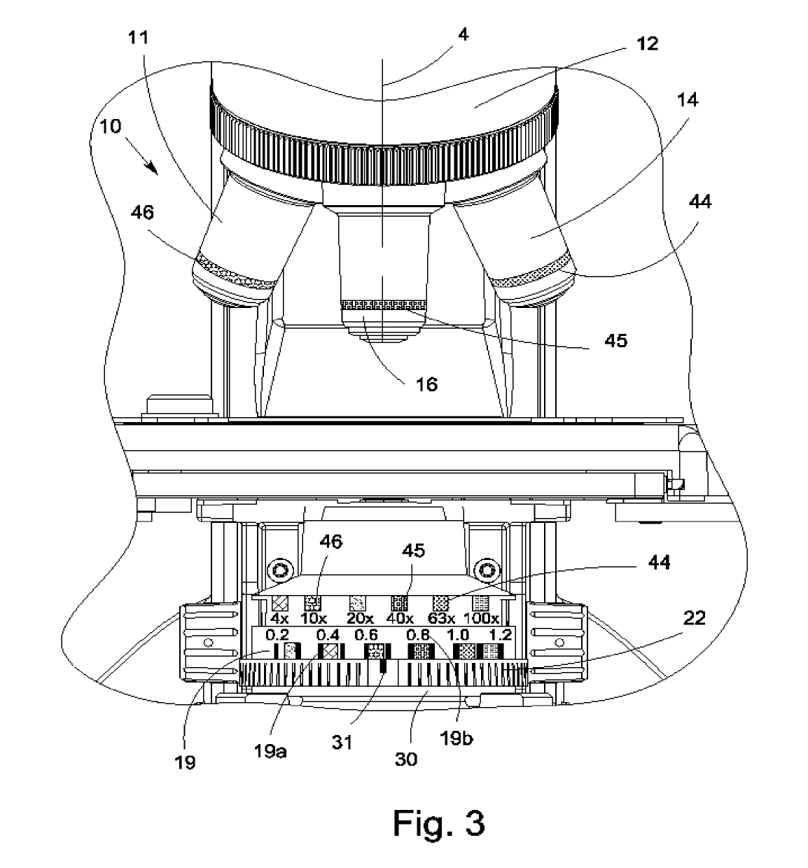

FIG. 3 is an enlarged view of a further embodiment of the region of microscope 10 that contains the invention. In this context, elements 44, 45, 46 on objectives 11, 14, 16 and on the identifying component are embodied as graphical patterns. Each objective 11, 14, 16 is provided with a different graphical pattern. The setting of the diaphragm of condenser 30 which matches objective 16 that is in the working position is achieved when index 31 on diaphragm setting ring 22 is in line with element 44, 45, 46 (in this case a graphical pattern). The individual elements on the objectives are embodied as rings. It is self-evident that elements 44, 45, 46 can also be implemented in color.

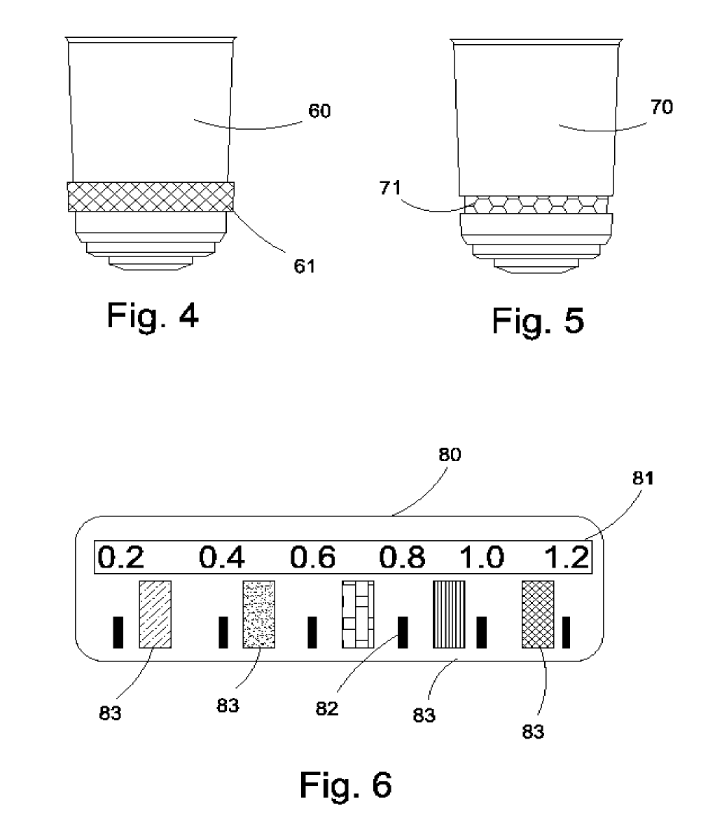

FIG. 4 shows an embodiment of the implementation of an element 61 on an objective 60. Although only the objective is depicted here, it is self-evident that this type of implementation of the element can also be carried out on identifying component 22. The elements are implemented, both on identifying component 22 and on the objectives inserted in nosepiece 12, in raised fashion. The elements, which can be a graphical shape, a graphical pattern, or a ring, form an elevation 61.

FIG. 5 shows a further embodiment of the implementation of an element on objective 70. Although only the objective is depicted here, it is self-evident that this type of implementation of the element can also be carried out on identifying component 22. The elements are implemented, both on identifying component 22 and on the objectives inserted in the nosepiece, as an engraving. The elements can be a graphical shape, a graphical pattern, or a ring that is implemented as a depression. It is particularly advantageous in the case of engraving if it is additionally provided with an overprinting in color.

FIG. 6 shows an embodiment of the identifying component that is implemented as an adhesive label 80. Adhesive label 80 is rectangular and is applied onto identifying component 22 of condenser 30. Adhesive label 80 encompasses a field 81 in which the relative sizes of the diaphragm opening are applied. A graduation mark 82 is associated with each of the relative sizes of the diaphragm opening. Elements 83, which are also applied onto the objectives, are provided between or on the graduation marks. As already mentioned several times, the elements can differ from one another solely in terms of their color. A setting that is optimal for a specific objective is achieved when the index of diaphragm setting ring 22 is located at the element having the same color as the element on the objective that is currently in the working position.

1. A microscope comprising: a condenser; a nosepiece which carries a plurality of objectives with an objective currently in a working position, wherein one objective in each instance is brought by the nosepiece in the working position, at least one displaceable diaphragm setting ring provided at the condenser to adjust a diaphragm of the condenser, wherein the at least one diaphragm setting ring has associated with it an identifying component that encompasses several individual different elements; and each of the objectives carries an element that corresponds respectively to an element on the identifying component.

2. The microscope as defined in claim 1, wherein a microscope stage mounted on the microscope is provided between the condenser and the nosepiece.

3. The microscope as defined in claim 1, wherein an index that indicates the position of the diaphragm setting ring is mounted on the diaphragm setting ring.

4. The microscope as defined in claim 1, wherein the identifying component is provided above the diaphragm setting ring.

5. The microscope as defined in claim 1, wherein the elements of the identifying component and the elements on the objectives are of the same type.

6. The microscope as defined in claim 5, wherein the elements are graphical shapes.

7. The microscope as defined in claim 6, wherein the elements differ from one another in terms of color.

8. The microscope as defined in claim 5, wherein the elements are graphical patterns.

9. The microscope as defined in claim 8, wherein the elements differ from one another in terms of color.

10. The microscope as defined in claim 1, wherein the elements on the identifying component and on the objectives inserted in the nosepiece are implemented in raised fashion.

11. The microscope as defined in claim 1, wherein the elements on the identifying component and on the objectives inserted in the nosepiece are applied as engraving.

12. The microscope as defined in claim 1, wherein the elements on the identifying component and on the objectives inserted in the nosepiece are applied as overprinting.

13. The microscope as defined in claim 12, wherein the overprinting (80) is color overprinting.

14. The microscope as defined in claim 1, wherein the position of each element on the identifying component corresponds to an aperture size of the diaphragm of the condenser that is optimal for the objective that is in a working position and is equipped with the same element.

15. The microscope as defined in claim 14, wherein setting of the optimum aperture is accomplished by the fact that an index on the diaphragm setting ring points to the element that is applied on the objective that is in the working position.

16. The microscope as defined in claim 1, wherein the element on the objective is a recessed ring that is provided with a color.

17. The microscope as defined in claim 16, wherein the different elements on the identifying component are presented as colored bars that correspond to the colors of the recessed ring provided on the various objectives.

18. The microscope as defined in claim 1, wherein the identifying component is provided with an adhesive label that carries the different elements.

19. The microscope as defined in claim 1, wherein in addition to the identifying component of the condenser, an information element is provided on which a correlation of the individual elements with the individual magnifications of the objectives is effected.
